(19) United States
(12) Patent Application Publication
(10) Pub. No.: US 2012/0089811 A1
(43) Pub. Date: Apr. 12, 2012

(54) ADDRESS CONVERSION APPARATUS

(75) Inventor: Takatsugu SAWAI, Osaka (JP)

(73) Assignee: Panasonic Corporation, Osaka (JP)

(21) Appl. No.: 13/329,912

(22) Filed: Dec. 19, 2011

Related U.S. Application Data
(63) Continuation of application No. PCT/JP2010/000019, filed on Jan. 5, 2010.

(30) Foreign Application Priority Data
Jul. 8, 2009 (JP) 2009-162135

(51) Int. Cl. G06F 12/00

(52) U.S. Cl. 711/207; 711/E12.001

(57) ABSTRACT

An address conversion apparatus includes a TLB, and an address conversion control section configured to count a consecutive address number indicating the number of consecutive addresses from a pair of a logical address and a physical address stored in the TLB with reference to an address conversion table, store the consecutive address number in association with the pair of the logical address and the physical address, determine whether a conversion target address is included in a range of the consecutive address number from the logical address stored in the TLB or not, and add, if the conversion target address is included in the range, a difference between the logical address and the conversion target address to the physical address which forms a pair with the logical address to calculate a converted physical address.

### CROSS-REFERENCE TO RELATED APPLICATION

This is a continuation of PCT International Application PCT/JP2010/000019 filed on Jan. 5, 2010, which claims priority to Japanese Patent Application No. 2009-162135 filed on Jul. 8, 2009. The disclosures of these applications including the specifications, the drawings, and the claims are hereby incorporated by reference in its entirety.

### BACKGROUND

The present disclosure relates to an address conversion apparatus, and more particularly to an address conversion technique using a translation look-aside buffer (TLB).

In general, a TLB is used as an address translation mechanism to convert a logical address that a program uses on a computer to a physical address. A size of an address space, i.e., a block size which can be converted by one entry stored in the TLB is fixed. Therefore, even when consecutive logical addresses and consecutive physical addresses corresponding to the logical addresses are stored in the TLB, a corresponding number of TLB entries to the number of the logical addresses are needed, and thus, the TLB entries are redundantly used. When the number of addresses stored in the TLB is increased, a time required to search an address to be converted is increased, thus preventing increase in the address conversion speed. Therefore, it is desired to reduce the number of addresses stored in the TLB.

Thus, as a means for reducing the number of addresses, an address conversion apparatus in which a TLB is stratified to allow a user to specify the number of significant bits which are to be address-converted in each layer of the TLB so that an address space reduces from an upper layer to a lower layer has been disclosed (see, for example, Japanese Patent Publication No. H4-360252). In the address conversion apparatus, when a larger continuous physical address space corresponds to a continuous logical address space, the number of addresses stored in the TLB can be reduced by using the upper layer of the TLB for which the number of significant bits is set larger.

### SUMMARY

In conventional address conversion apparatuses, it is assumed that a user knows the number of significant bits which are to be address-converted. Since the number of significant bits varies depending on each application, it is difficult to dynamically change a TLB which is allocated to each application. That is, a TLB that an application uses cannot be always used by another application, and the usability of the TLB might be reduced.

In an address conversion apparatus according to the present disclosure, even when a user does not specify the number of significant bits which are to be address-converted, an address conversion table can be efficiently cached to a TLB.

An example address conversion apparatus for converting a logical address to a physical address includes a translation look-aside buffer (TLB), and an address conversion control section configured to count a consecutive address number indicating the number of consecutive addresses from a pair of a logical address and a physical address stored in the TLB with reference to an address conversion table, store the consecutive address number in association with the pair of the logical address and the physical address, determine whether a conversion target address is included in a range of the consecutive address number from the logical address stored in the TLB or not, and add, if the conversion target address is included in the range, a difference between the logical address and the conversion target address to the physical address which forms a pair with the logical address to calculate a converted physical address.

Thus, the consecutive address number indicating a size of an address space is set for each pair of a logical address and a physical address stored in the TLB, and if the conversion target address is included in the address space, there is a TLB hit. Therefore, even when a user does not specify the number of bits to be address-converted, the size of the address space can be dynamically set. Moreover, when addresses are consecutive, the addresses can be efficiently stored in the TLB.

Another example address conversion apparatus for converting a logical address to a physical address includes a translation look-aside buffer (TLB), and an address conversion control section configured to count a consecutive address number indicating the number of consecutive addresses from a pair of a logical address and a physical address, respective logical values of lower n bits of which are all the same and which are stored in the TLB with reference to an address conversion table, round the consecutive address number to 2ⁿ−1 to store the rounded consecutive address number in association with the pair of the logical address and the physical address, compare a conversion target address to the logical address stored in the TLB after excluding lower n bits of the conversion target address and the logical address, and replace, if the conversion target address and the logical address after excluding the lower n bits match each other, the lower n bits of the physical address which forms a pair with the logical address with the lower n bits of the conversion target address to calculate a converted physical address.

Thus, the consecutive address number indicating a size of an address space for each pair of a logical address and a physical address stored in the TLB, and if the conversion target address is included in the address space, there is a TLB hit. Therefore, even when a user does not specify the number of bits to be address-converted, the size of the address space can be dynamically set. Furthermore, in performing address conversion, the conversion target address is compared to the logical address stored in the TLB after excluding lower n bits of the conversion target address and the logical address, and if the conversion target address and the logical address after excluding the lower n bits match each other, the lower n bits of the physical address is replaced with the lower n bits of the conversion target address. Thus, the numbers of bits of a comparison target address and a conversion target address are reduced, and thus, the speed of address conversion processing can be increased.

According to one embodiment, using the pair of the logical address and the physical address stored in the TLB as references, the address conversion control section increments or decrements the references, and counts up, if incremented or decremented addresses are included in the address conversion table, the consecutive address number.

According to one embodiment, using the pair of the logical address and the physical address stored in the TLB as first references and second references, the address conversion control section increments the first references, counts up, if incremented addresses are included in the address conversion table, the consecutive address number, decrements the second references, counts up, if decremented addresses are included in the address conversion table, the consecutive address number, and replaces the pair of the logical address and the physical address stored in the TLB with initial addresses or end addresses in a continuous address space between the first references and the second references. Thus, consecutive addresses can be covered all from an initial address, and thus, the addresses can be further efficiently stored in the TLB.

Preferably, during an idle time during which address conversion is not required, the address conversion control section counts the consecutive address number and stores the counted consecutive address number in the TLB. Thus, the consecutive address number can be stored in the TLB without degrading performance of address conversion using the TLB.

### BRIEF DESCRIPTION OF THE DRAWINGS

FIG. 1 is a diagram illustrating a configuration of an address conversion apparatus according to a first embodiment.

FIG. 2 is a diagram illustrating an example of address conversion processing to addresses stored in a TLB.

FIG. 3 is a diagram illustrating another example of address conversion processing to addresses stored in a TLB.

FIG. 4 is a diagram illustrating still another example of address conversion processing to addresses stored in a TLB.

FIG. 5 is a block diagram schematically illustrating a configuration a semiconductor device according to a second embodiment.

### DETAILED DESCRIPTION

Embodiments will be described below with reference to the accompanying drawings.

### First Embodiment

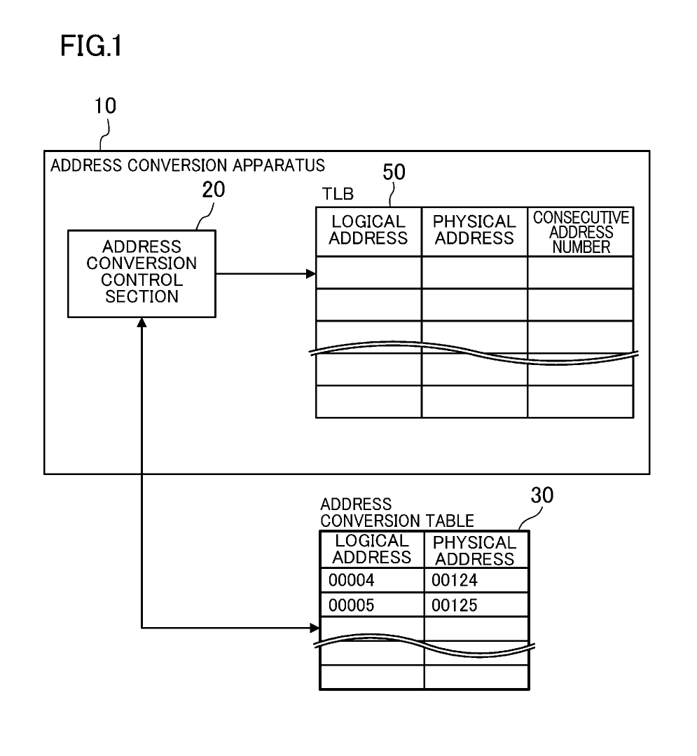

FIG. 1 is a block diagram illustrating a configuration of an address conversion apparatus 10 according to a first embodiment. In the address conversion apparatus 10, an address conversion control section 20 stores a pair of a logical address and a physical address in a TLB 50 with reference to an address conversion table 30 externally provided. Furthermore, a consecutive address number indicating the number of consecutive addresses from the pair of the logical address and the physical address is stored in the TLB 50 in association with the pair of the logical address and the physical address. The address conversion control section 20 converts, for example, a logical address (a conversion target address) requested by a program on a computer to a physical address (a converted physical address) corresponding to the conversion target address with reference to the TLB 50.

Storage processing for storing the logical address, the physical address, and the consecutive address number in the TLB 50 and address conversion processing according to the storage processing will be described below.

### First Example

The address conversion control section 20 stores a logical address and a physical address corresponding to the logical address in the TLB 50, and counts a consecutive address number, using the addresses as references, with reference to the address conversion table 30. Specifically, if incremented logical and physical addresses are included in the address conversion table 30, the address conversion control section 20 increments the consecutive address number. The forgoing is repeated until the incremented addresses from the reference logical and physical addresses are no longer included in the address conversion table 30.

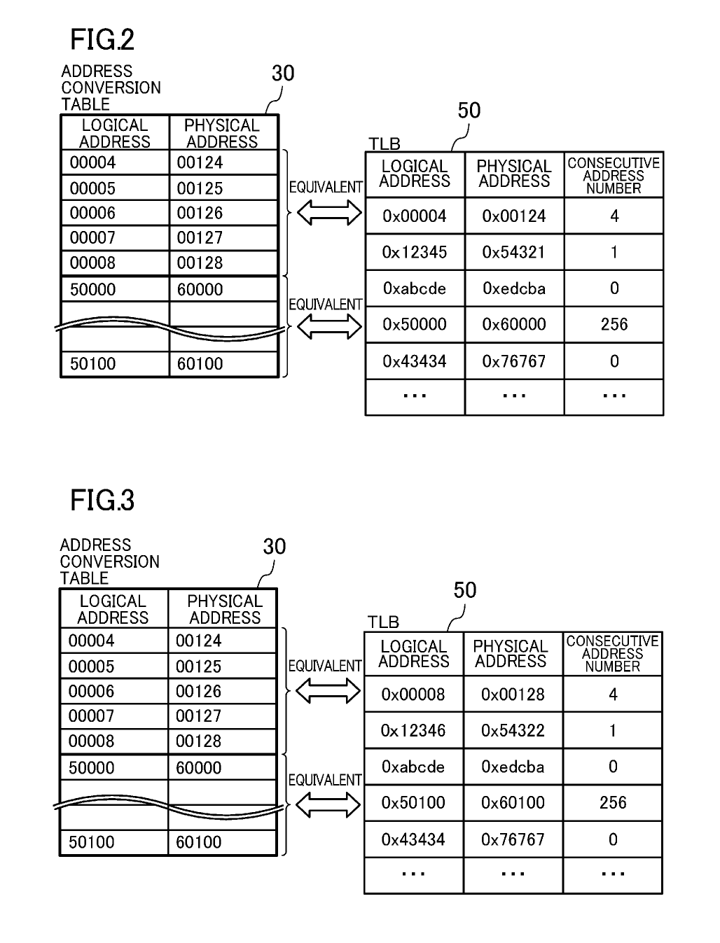

For example, as shown in FIG. 2, a logical address 0x00004 and a physical address 0x00124 which are to be references are stored in the TLB 50, and the consecutive address number is counted from 0. Since a logical address 0x00005 and a physical address 0x00125 incremented from the references are included in the address conversion table 30, the address conversion control section 20 increments the consecutive address number. Furthermore, a logical address 0x00006 and a physical address 0x00126 further incremented from the references are included in the address conversion table 30, the address conversion control section 20 increments the consecutive address number. The foregoing is repeated until the addresses incremented from the reference logical and physical addresses are no longer included in the address conversion table 30. Then, when a logical address 0x00009 and a physical address 0x00129 incremented from the references are not included in the address conversion table 30, the incrementing of the references is terminated, and the consecutive address number is set to be 4.

Next, address conversion processing by the address conversion control section 20 will be described. The address conversion control section 20 determines, based on a logical address stored in the TLB 50, whether or not the conversion target address is included in a range of the consecutive address number associated with the logical address. If the conversion target address is included in the range, there is a TLB hit, and a difference between the conversion target address and the logical address is added to the physical address.

For example, assume that the conversion target address is 0x00007. Since the consecutive address number associated to the logical address 0x00004 is 4, the conversion target address 0x00007 is included in the range from the logical address 0x00004 to the logical address 0x00008, and there is a TLB hit. Thus, the address conversion control section 20 adds 3, which is a difference between the conversion target address 0x00007 and the logical address 0x00004 to the physical address 0x000124 to calculate a converted physical address 0x000127.

In the manner described above, even when a user is not aware of the number of bits which are to be address-converted, the consecutive address number indicating the continuous address space can be dynamically set. Also, when addresses are consecutive, the addresses can be efficiently stored in the TLB 50.

### Second Example

The address conversion control section 20 increments the consecutive address number, if logical and physical addresses decremented from the references are included in the address conversion table 30. The foregoing is repeated until the addresses decremented from the references are no longer included in the address conversion table 30.

For example, as shown in FIG. 3, the address conversion control section 20 stores a logical address 0x00008 and a physical address 0x00128 in the TLB 50, and counts the consecutive address number from 0. Since a logical address 0x00007 and a physical address 0x00127 decremented from the references are included in the address conversion table 30, the address conversion control section 20 increments the consecutive address number. Furthermore, a logical address 0x00006 and a physical address 0x00126 further decremented from the references are included in the address conversion table 30, and thus, the address conversion control section 20 increments the consecutive address number. The foregoing is repeated until the addresses decremented from the references are no longer included in the address conversion table 30. Then, when a logical address 0x00003 and a physical address 0x00123 decremented from the references are not included in the address conversion table 30, the decrementing of the references is terminated, and the consecutive address number is set to be 4.

Next, conversion processing by the address conversion control section 20 will be described. For example, assume that a conversion target address is 0x00007. Since the consecutive address number associated with the logical address 0x00008 is 4, the conversion target address 0x00007 is included in the range from the logical address 0x00008 to the logical address 0x00004, and there is a TLB hit. Thus, the address conversion control section 20 adds −1, a difference between the conversion target address 0x00007 and the logical address 0x00008 to the physical address 0x000128 to calculate a converted physical address 0x000127.

In the manner described above, even when a user is not aware of the number of bits which are to be address-converted, the consecutive address number indicating the continuous address space can be dynamically set. Also, when addresses are consecutive, the addresses can be efficiently stored in the TLB 50.

### Third Example

The address conversion control section 20 increments the consecutive address number, if logical and physical addresses incremented from the references are included in the address conversion table 30. The foregoing is repeated until the addresses incremented from the references are no longer included.

The address conversion control section 20 changes the references back to what they were, and if decremented logical and physical addresses are included in the address conversion table 30, the address conversion control section 20 increments the consecutive address number. The foregoing is repeated until the addresses decremented from the references are no longer included in the address conversion table 30.

For example, in FIG. 2, assume that the address conversion control section 20 stores 0x00005 and 0x00125 as the logical address and the physical address, not 0x00004 and 0x00124. The consecutive address number is counted from 0. Since a logical address 0x00006 and a physical address 0x00126 incremented from the references are included in the address conversion table 30, the address conversion control section 20 increments the consecutive address number. The foregoing is repeated until the addresses incremented from the references are no longer included in the address conversion table 30. Then, when a logical address 0x00009 and a physical address 0x00129 incremented from the references are not included in the address conversion table 30, the incrementing of the references is terminated, and the consecutive address number is set to be 3.

Thereafter, the references are changed back to the logical address 0x00005 and the physical address 0x00125. Then, a logical address 0x00004 and a physical address 0x00124 decremented from the references are included in the address conversion table 30, and thus, the address conversion control section 20 increments the consecutive address number. The foregoing is repeated until the addresses decremented from the references are no longer included in the address conversion table 30. Then, when a logical address 0x00003 and a physical address 0x00123 decremented from the references are not included in the address conversion table 30, the incrementing of the references is terminated, and the consecutive address number is set to be 4. At the same time, the logical address 0x00005 and the physical address 0x00125 stored in the TLB 50 are overwritten with the logical address 0x00004 and the physical address 0x00124. A similar address conversion processing to the address conversion processing of the first or second example is used in this example, and therefore, the description thereof will be omitted.

In the manner described above, consecutive addresses can be covered all from an initial address, and thus, the addresses can be further efficiently stored in the TLB 50. Note that incrementing may be performed after decrementing is performed. In this case, the logical address 0x00005 and the physical address 0x00125 stored in the TLB 50 may be overwritten with a logical address 0x00008 and a physical address 0x00128.

### Fourth Example

The address conversion control section 20 increments the consecutive address number, if logical and physical addresses incremented from the references are included in the address conversion table 30. The foregoing is repeated until the addresses incremented from the references are no longer included in the address conversion table 30, and the address conversion control section 20 rounds the consecutive address number to 2ⁿ−1. Note that respective logical values of lower n bits of the pair of the logical address and the physical address are all the same.

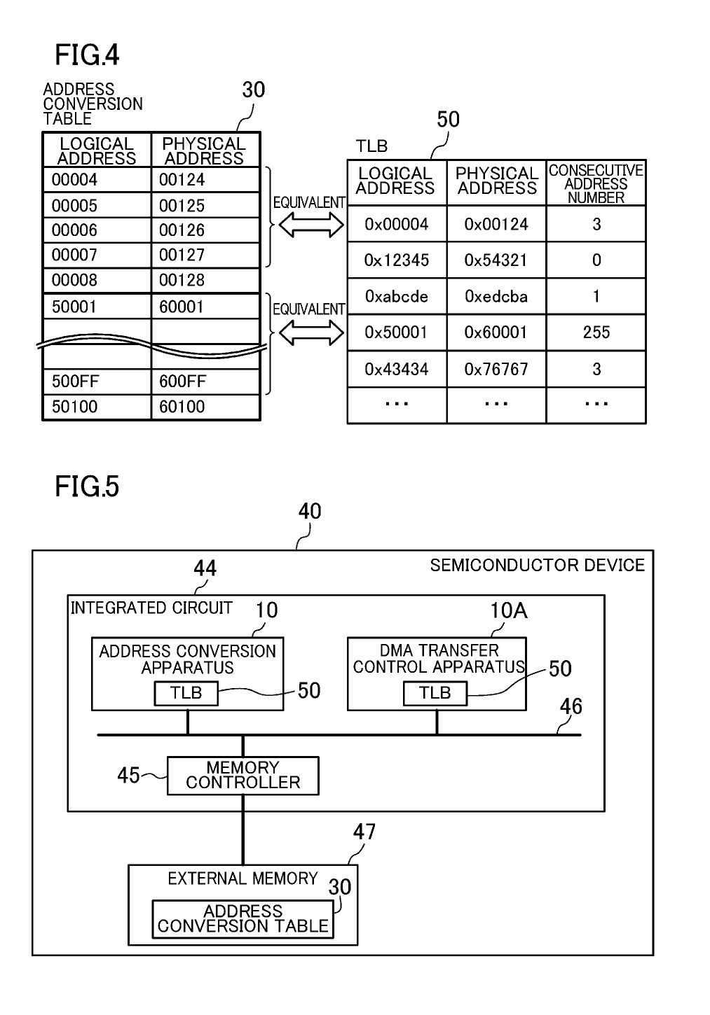

For example, as shown in FIG. 4, the address conversion control section 20 stores a logical address 0x00004 and a physical address 0x00124 in the TLB 50, and counts the consecutive address number from 0. Since a logical address 0x00005 and a physical address 0x00125 incremented from the references are included in the address conversion table 30, the address conversion control section 20 increments the consecutive address number. Furthermore, a logical address 0x00006 and a physical address 0x00126 incremented from the references are included in the address conversion table 30, and thus, the address conversion control section 20 increments the consecutive address number. The foregoing is repeated until the addresses incremented from the references are no longer included in the address conversion table 30. Then, when a logical address 0x00009 and a physical address 0x00129 are not included in the address conversion table 30, the incrementing of the references is terminated, and the consecutive address is 4 and is rounded to 3, which corresponds to 2ⁿ⁻¹ when n=2.

Next, address conversion processing by the address conversion control section 20 will be described. The address conversion control section 20 compares a conversion target address to a logical address stored in the TLB 50 after excluding lower 2 bits of the conversion target address and the logical address. Then, if the conversion target address and the logical address after excluding the lower n bits match each other, the address conversion control section 20 replaces the lower n bits of the compared address.

For example, assume that a conversion target address is 0x00006. Since the consecutive address number associated with a logical address 0x00004 is 3, lower 2 bits are excluded. That is, the address conversion control section 20 compares bits of the conversion target address 0x00006 after excluding the lower 2 bits “10” to bits of the logical address 0x00004 after excluding the lower 2 bits “00.” As a result, the respective bits of the conversion target address and the logical address after excluding the lower 2 bits match each other, and thus, there is a TLB hit. Then, the address conversion control section 20 replaces the lower 2 bits “00” of the physical address 0x00124 with the lower 2 bits “10” of the conversion target address 0x00006 to calculate a converted physical address 0x00126.

In the manner described above, when address conversion is performed, the numbers of bits of a comparison target address and a conversion target address are reduced, and thus, the speed of address conversion processing can be increased. Note that the references may be decremented to count the consecutive address.

In each of the above-described examples, it is preferable that the consecutive address number is counted and stored in the TLB 50 during an idle time during which address conversion is not requested. Thus, the consecutive address number can be counted without degrading performance of address conversion.

Also, the address conversion control section 20 may be configured to read, with reference to the address conversion table 30, a pair of a logical address and a physical address corresponding to a predetermined address space together at a time, and temporarily hold the read pair, when counting the consecutive address number. In this case, the consecutive address number may be counted from the pair of addresses temporarily held.

Also, the consecutive address number may be counted from 1. In this case, when the consecutive address number is 1, only a pair of a logical address and a physical address stored in the TLB 50 becomes an address space. When the consecutive address number is 2 or larger, consecutive addresses corresponding to the consecutive address number become an address space.

The number by which the references are incremented or decremented does not have to be 1. For example, the number may be 2.

In the TLB 50, as information other than the logical address, physical address, and consecutive address number, for example, a flag to indicate whether consecutive addresses exist or not may be stored.

In the fourth example, the logical values of the lower n bits of a logical address and a physical address stored in the TLB 50 have to be all the same. However, in other examples, the logical values of the lower n bits thereof do not have to be all the same.

### Second Embodiment

FIG. 5 is a block diagram schematically illustrating a configuration of a semiconductor device 40 according to a second embodiment. An integrated circuit 44 inputs/outputs data from/to an external memory 47 via an input/output bus 46. With reference to an address conversion table 30 held in the external memory 47, an address conversion apparatus 10 and a DMA transfer control apparatus 10A store a logical address and a physical address in respective TLBs 50 of the address conversion apparatus 10 and the DMA transfer control apparatus 10A, and count a consecutive address number. A memory controller 45 controls the address conversion apparatus 10 and the DMA transfer control apparatus 10A. Note that each of the address conversion apparatus 10 and the DMA transfer control apparatus 10A is the address conversion apparatus of FIG. 1. Since consecutive addresses are basically used in DMA transfer, the address conversion table 30 can be efficiently cached to the TLBs 50.

According to this embodiment, the address conversion table 30 can be efficiently cached to the TLBs 50 by the address conversion apparatus 10 and the DMA transfer control apparatus 10A. Thus, error TLB hits are reduced. Therefore, even when the address conversion table 30 is held in the external memory 47 whose transfer speed is low, reduction in speed of address conversion processing due to error TLB hits can be prevented.

What is claimed is:

1. An address conversion apparatus for converting a logical address to a physical address, the apparatus comprising:
a translation look-aside buffer (TLB); and
an address conversion control section configured to count a consecutive address number indicating the number of consecutive addresses from a pair of a logical address and a physical address stored in the TLB with reference to an address conversion table, store the consecutive address number in association with the pair of the logical address and the physical address, determine whether a conversion target address is included in a range of the consecutive address number from the logical address stored in the TLB or not, and add, if the conversion target address is included in the range, a difference between the logical address and the conversion target address to the physical address which forms a pair with the logical address to calculate a converted physical address.

2. The address conversion apparatus of claim 1, wherein
using the pair of the logical address and the physical address stored in the TLB as references, the address conversion control section increments the references, and counts up, if incremented addresses are included in the address conversion table, the consecutive address number.

3. The address conversion apparatus of claim 1, wherein
using the pair of the logical address and the physical address stored in the TLB as references, the address conversion control section decrements the references, and counts up, if decremented addresses are included in the address conversion table, the consecutive address number.

4. The address conversion apparatus of claim 1, wherein
using the pair of the logical address and the physical address stored in the TLB as first references and second references, the address conversion control section increments the first references, counts up, if incremented addresses are included in the address conversion table, the consecutive address number, decrements the second references, counts up, if decremented addresses are included in the address conversion table, the consecutive address number, and replaces the pair of the logical address and the physical address stored in the TLB with initial addresses or end addresses in a continuous address space between the first references and the second references.

5. The address conversion apparatus of claim 1, wherein
during an idle time during which address conversion is not required, the address conversion control section counts the consecutive address number and stores the counted consecutive address number in the TLB.

6. The address conversion apparatus of claim 1, wherein
the address conversion apparatus is a DMA transfer control apparatus.

7. A semiconductor device, comprising:
the address conversion apparatus of claim 1; and
an external memory configured to hold an address conversion table,
wherein
the address conversion apparatus counts the consecutive address number and stores the counted consecutive address number in the TLB in the address conversion apparatus with reference to an address conversion table in the external memory.

8. An address conversion apparatus for converting a logical address to a physical address, the apparatus comprising:
a translation look-aside buffer (TLB); and
an address conversion control section configured to count a consecutive address number indicating the number of consecutive addresses from a pair of a logical address and a physical address, respective logical values of lower n bits of which are all the same and which are stored in the TLB with reference to an address conversion table, round the consecutive address number to 2ⁿ−1 to store the rounded consecutive address number in association with the pair of the logical address and the physical address, compare a conversion target address to the logical address stored in the TLB after excluding lower n bits of the conversion target address and the logical address, and replace, if the conversion target address and the logical address after excluding the lower n bits match each other, the lower n bits of the physical address which forms a pair with the logical address with the lower n bits of the conversion target address to calculate a converted physical address.

9. The address conversion apparatus of claim 8, wherein
using the pair of the logical address and the physical address stored in the TLB as references, the address conversion control section increments the references, and counts up, if incremented addresses are included in the address conversion table, the consecutive address number.

10. The address conversion apparatus of claim 8, wherein
using the pair of the logical address and the physical address stored in the TLB as references, the address conversion control section decrements the references, and counts up, if decremented addresses are included in the address conversion table, the consecutive address number.

11. The address conversion apparatus of claim 8, wherein
using the pair of the logical address and the physical address stored in the TLB as first references and second references, the address conversion control section increments the first references, counts up, if incremented addresses are included in the address conversion table, the consecutive address number, decrements the second references, counts up, if decremented addresses are included in the address conversion table, the consecutive address number, replaces the pair of the logical address and the physical address stored in the TLB with initial addresses or end addresses in a continuous address space between the first references and the second references.

12. The address conversion apparatus of claim 8, wherein
during an idle time during which address conversion is not required, the address conversion control section counts the consecutive address number and stores the counted consecutive address number in the TLB.

13. The address conversion apparatus of claim 8, wherein
the address conversion apparatus is a DMA transfer control apparatus.

14. The address conversion apparatus of claim 8, further comprising:
an external memory configured to hold an address conversion table,
wherein
the address conversion apparatus counts a consecutive address number, and stores the counted consecutive address number in the TLB in the address conversion apparatus with reference to the address conversion table in the external memory.

15. An address conversion method for converting a logical address to a physical address, the method comprising:
counting a consecutive address number indicating the number of consecutive addresses from a pair of a logical address and a physical address stored in a translation look-aside buffer (TLB) with reference to an address conversion table;
associating the consecutive address number with the pair of the logical address and the physical address;
determining whether a conversion target address is included in a range of the consecutive address number from the logical address stored in the TLB or not; and
adding, if the conversion target address is included in the range, a difference between the logical address stored in the TLB and the conversion target address to the physical address which forms a pair with the logical address to calculate a converted physical address.

16. An address conversion method for converting a logical address to a physical address, the method comprising:
counting a consecutive address number indicating the number of consecutive addresses from a pair of a logical address and a physical address, respective logical values of lower n bits of which are all the same and which are stored in a translation look-aside buffer (TLB) with reference to an address conversion table;
rounding the consecutive address number to 2ⁿ−1 and associating the rounded consecutive address number with the pair of the logical address and the physical address;
comparing a conversion target address to the logical address stored in the TLB after excluding lower n bits of the conversion target address and the logical address; and
replacing, if a result of the comparison shows that the conversion target address and the logical address after excluding the lower n bits match each other, the lower n bits of the physical address which forms a pair with the logical address with the lower n bits of the conversion target address to calculate a converted physical address.
